(19) United States
(12) Patent Application Publication
(10) Pub. No.: US 2026/0205409 A1
(43) Pub. Date: Jul. 16, 2026

(54) Adaptive Routing Profiles

(71) Applicant: Mellanox Technologies, Ltd., Yokneam (IL)

(72) Inventors: Alex Shpiner, Ramat Yishay (IL); Gil Levy, Hod Hasharon (IL); Orel Hagag, Beer Sheba (IL); Omer Shabtai, Tel Aviv (IL); Matty Kadosh, Caesarea (IL); Adi Horowitz, Lehavot Habashan (IL)

(21) Appl. No.: 19/422,552

(22) Filed: Dec. 17, 2025

Related U.S. Application Data
(60) Provisional application No. 63/744,150, filed on Jan. 10, 2025.

(51) Int. Cl. H04L 45/12; H04L 47/2408

(52) U.S. Cl. CPC H04L 45/124; H04L 47/2408

(57) ABSTRACT

In one embodiment, a network device includes a plurality of ports to receive packets, and processing circuitry to determine adaptive routing profile classifications of the received packets, make adaptive routing decisions for the packets based on different adaptive routing profiles associated with the adaptive routing profile classifications of the packets, and forward the received packets to the ports according to the adaptive routing decisions.

### RELATED APPLICATION INFORMATION

The present application claims benefit of US Provisional Patent Application S/N 63/774,150 of Shpiner, et al., filed 19 March 2025, the disclosure of which is hereby incorporated herein by reference.

### FIELD OF THE DISCLOSURE

The present disclosure relates to network routing, and more particularly but not exclusively to adaptive routing.

### BACKGROUND

Adaptive routing is a network routing technique that dynamically adjusts the path selection for data packets based on current network conditions. In traditional static routing, packets follow predetermined paths between source and destination. However, adaptive routing allows the network to respond to changes in topology, congestion, or failures by modifying routing decisions in real-time.

In adaptive routing systems, routers or switches or multi-port network interface controllers (NICs) continuously monitor network metrics such as queue depths, link utilization, and latency. Based on these measurements, the routing algorithm can select alternative paths to avoid congested or failed links, thereby improving overall network performance and reliability.

A concept in adaptive routing is the use of grades or scores to represent the desirability of different egress ports or paths. These grades are typically calculated based on congestion levels, with lower grades indicating less congested paths.

The routing algorithm identifies ports that are reachable to the packet's destination (usually by minimal hop route, although in some topologies, non-minimal routes are also considered). Adaptive routing is the logic that selects the single best port among these reachable ports, typically choosing ports with the best grades (i.e., lowest grades) for forwarding packets.

As networks become more complex and handle an increasing variety of applications and traffic patterns, there is interest in developing more sophisticated adaptive routing techniques. These techniques aim to provide greater flexibility and optimization for different types of network traffic, potentially improving overall network efficiency and performance.

### OVERVIEW

There is provided in accordance with an embodiment of the present disclosure, a network device comprising a plurality of ports to receive packets, and processing circuitry to determine adaptive routing profile classifications of the received packets, make adaptive routing decisions for the packets based on different adaptive routing profiles associated with the adaptive routing profile classifications of the packets, and forward the received packets to the ports according to the adaptive routing decisions.

Further in accordance with an embodiment of the present disclosure, at least some of the ports are to receive the packets of a first adaptive routing profile classification and a second adaptive routing profile classification, and the processing circuitry is to make the adaptive routing decisions for the packets of the first adaptive routing profile classification based on a first adaptive routing profile associated with the first adaptive routing profile classification, and the packets of the second adaptive routing profile classification based on a second adaptive routing profile associated with the second adaptive routing profile classification.

Still further in accordance with an embodiment of the present disclosure, the first adaptive routing profile and the second adaptive routing profile include different thresholds for grading the ports.

Additionally in accordance with an embodiment of the present disclosure, the processing circuitry is to assign a first set of grades to the ports for the first adaptive routing profile classification based on at least one first threshold specified in the first adaptive routing profile, assign a second set of grades to the ports for the second adaptive routing profile classification based on at least one second threshold specified in the second adaptive routing profile, and make adaptive routing decisions for the packets based on the first set of grades of the ports for the first adaptive routing profile classification and the second set of grades of the ports for the second adaptive routing profile classification.

Moreover, in accordance with an embodiment of the present disclosure, the first adaptive routing profile classification has a lower bandwidth share of traffic than the second adaptive routing profile classification, and the first adaptive routing profile includes lower thresholds for grading the ports compared to the second adaptive routing profile.

Further in accordance with an embodiment of the present disclosure, the processing circuitry is to make the adaptive routing decisions for the packets of the first adaptive routing profile classification using a first routing mode based on the first adaptive routing profile, and make the adaptive routing decisions for the packets of the second adaptive routing profile classification using a second routing mode based on the second adaptive routing profile.

Still further in accordance with an embodiment of the present disclosure, the processing circuitry is to make the adaptive routing decisions for the packets of the first adaptive routing profile classification using sticky routing based on the first adaptive routing profile, and make the adaptive routing decisions for the packets of the second adaptive routing profile classification using free routing based on the second adaptive routing profile.

Additionally in accordance with an embodiment of the present disclosure, the network device further comprises a memory to store a mapping between the different adaptive routing profiles and the different adaptive routing profile classifications, and data of the different adaptive routing profiles.

Moreover, in accordance with an embodiment of the present disclosure, the processing circuitry is to determine the adaptive routing profile classifications of the packets based on information in headers of the received packets.

Additionally in accordance with an embodiment of the present disclosure, the adaptive routing profile classifications are based on one or more of: traffic classes indicated in the headers of the received packets; protocol types indicated in the headers of the received packets; eligibility of the packets for adaptive routing as indicated in the headers of the received packets; Differentiated Services Code Point (DSCP) values in the headers of the received packets; Virtual LAN (VLAN) identifiers in the headers of the received packets; Service Level (SL) fields in InfiniBand headers of the received packets; port numbers in transport layer headers of the received packets; a distinction between TCP traffic and RDMA traffic; or a combination of multiple fields in the headers of the received packets.

There is provided in accordance with another embodiment of the present disclosure, a method for adaptive routing in a network device comprising receiving packets at a plurality of ports, determining adaptive routing profile classifications of the received packets, making adaptive routing decisions for the packets based on different adaptive routing profiles associated with the adaptive routing profile classifications of the packets, and forwarding the received packets to the ports according to the adaptive routing decisions.

There is provided in accordance with another embodiment of the present disclosure, a method for adaptive routing in a network device, comprising receiving packets at a plurality of ports, determining adaptive routing profile classifications of the received packets, making adaptive routing decisions for the packets based on different adaptive routing profiles associated with the adaptive routing profile classifications of the packets, and forwarding the received packets to the ports according to the adaptive routing decisions.

Further in accordance with an embodiment of the present disclosure, at least some of the ports receive packets of a first adaptive routing profile classification and a second adaptive routing profile classification, and making the adaptive routing decisions comprises making adaptive routing decisions for the packets of the first adaptive routing profile classification based on a first adaptive routing profile associated with the first adaptive routing profile classification, and making adaptive routing decisions for the packets of the second adaptive routing profile classification based on a second adaptive routing profile associated with the second adaptive routing profile classification.

Still further in accordance with an embodiment of the present disclosure, the first adaptive routing profile and the second adaptive routing profile include different thresholds for grading the ports.

Additionally in accordance with an embodiment of the present disclosure, the method further comprises assigning a first set of grades to the ports for the first adaptive routing profile classification based on at least one first threshold specified in the first adaptive routing profile, assigning a second set of grades to the ports for the second adaptive routing profile classification based on at least one second threshold specified in the second adaptive routing profile, and making adaptive routing decisions for the packets based on the first set of grades of the ports for the first adaptive routing profile classification and the second set of grades of the ports for the second adaptive routing profile classification.

Moreover, in accordance with an embodiment of the present disclosure, the first adaptive routing profile classification has a lower bandwidth share of traffic than the second adaptive routing profile classification, and the first adaptive routing profile includes lower thresholds for grading the ports compared to the second adaptive routing profile.

Further in accordance with an embodiment of the present disclosure, making the adaptive routing decisions comprises making the adaptive routing decisions for the packets of the first adaptive routing profile classification using a first routing mode based on the first adaptive routing profile, and making the adaptive routing decisions for the packets of the second adaptive routing profile classification using a second routing mode based on the second adaptive routing profile.

Still further in accordance with an embodiment of the present disclosure, making the adaptive routing decisions comprises making the adaptive routing decisions for the packets of the first adaptive routing profile classification using sticky routing based on the first adaptive routing profile, and making the adaptive routing decisions for the packets of the second adaptive routing profile classification using free routing based on the second adaptive routing profile.

Additionally in accordance with an embodiment of the present disclosure, the method further comprises storing in a memory a mapping between the different adaptive routing profiles and the different adaptive routing profile classifications, and data of the different adaptive routing profiles.

Further in accordance with an embodiment of the present disclosure, determining the adaptive routing profile classifications of the packets comprises determining the adaptive routing profile classifications based on information in headers of the received packets.

Additionally in accordance with an embodiment of the present disclosure, the adaptive routing profile classifications are based on one or more of: traffic classes indicated in the headers of the received packets; protocol types indicated in the headers of the received packets; eligibility of the packets for adaptive routing as indicated in the headers of the received packets; Differentiated Services Code Point (DSCP) values in the headers of the received packets; Virtual LAN (VLAN) identifiers in the headers of the received packets; Service Level (SL) fields in InfiniBand headers of the received packets; port numbers in transport layer headers of the received packets; a distinction between TCP traffic and RDMA traffic; or a combination of multiple fields in the headers of the received packets.

### BRIEF DESCRIPTION OF THE DRAWINGS

The present disclosure will be understood from the following detailed description, taken in conjunction with the drawings in which:

FIG. 1 is a simplified block diagram of a network device constructed and operative in accordance with an embodiment of the present disclosure;

FIG. 2 is a view of an example mapping table for use with the network device of FIG. 1;

FIG. 3 is a flowchart including steps in a method of operation of the network device of FIG. 1; and

FIG. 4 is a block diagram that schematically illustrates a computing system, e.g., a data center or a High-Performance Computing (HPC) cluster, in accordance with an embodiment of the present disclosure.

### DESCRIPTION OF EXAMPLE EMBODIMENTS

### OVERVIEW OF EXAMPLE EMBODIMENTS

Adaptive routing implementations often rely on a single, fixed adaptive routing profile for all packets, e.g., all traffic classes or transportation protocols within a network device. This approach may present challenges in networks handling diverse packet types with varying requirements and characteristics.

Traffic classes, also known as service classes or quality of service (QoS) classes, are categories used to differentiate and prioritize different types of network traffic packets. These classes allow network administrators to apply specific policies and treatments to various types of data flows. Traffic classes are typically indicated in packet headers, for example, in the Traffic Class field of IPv6 and IPv4 headers, e.g., Differentiated Services Code Point (DSCP), or the Virtual Lane (VL) field in InfiniBand.

Other examples of packet types that are currently treated the same for adaptive routing purposes may include packets with different transportation protocol types indicated in packet headers, such as TCP or UDP; packets with the different eligibility for adaptive routing as indicated in header fields; packets with the different DSCP values in IP headers; packets with different VLAN identifiers in Ethernet frames; packets with different Service Level fields in InfiniBand packet headers; packets with different port numbers in transport layer headers; packets that include TCP traffic and RDMA traffic; and packets with the different combinations of multiple fields in packet headers. Currently, each of these packet types may be associated with the same adaptive routing profiles that specify appropriate routing behaviors, thresholds, and modes for the corresponding packet types.

Adaptive routing systems that use a single, fixed routing profile for all packets within a network device face challenges in optimizing performance across diverse packet types with varying requirements. This one-size-fits-all approach may lead to suboptimal routing decisions, particularly in complex network environments.

For example, different network transport types may have varying sensitivities to packet reordering, which can significantly impact performance. For example, TCP works best when packets arrive in order, as out-of-order delivery can trigger congestion control mechanisms that reduce throughput. In contrast, RDMA over Converged Ethernet (RoCE) is less sensitive to packet reordering, allowing for more flexible routing decisions without the same performance penalties. The selected adaptive routing profile directly affects packet reordering because different profiles implement varying routing modes and port selection strategies. Profiles using sticky routing tend to maintain consistent paths for packets within a flow, minimizing reordering, while profiles using free routing dynamically select ports based on current congestion levels, potentially introducing more reordering but improving overall throughput for protocols that can tolerate it.

Embodiments of the present disclosure address at least some of the above drawbacks by providing a system and method that implements multiple adaptive routing profiles tailored to different packet types (e.g., traffic classes or protocols) within a single network device. Packets of different types (e.g., defined by packet header field information) e.g., packets from different traffic types, such as TCP traffic and RoCE traffic, may be assigned to separate adaptive routing profile classifications, allowing for customized routing strategies appropriate for each packet type.

In some embodiments, the network device stores data, such as a table providing a mapping between adaptive routing profile classifications and different adaptive routing profiles, and profile data. The device identifies the adaptive routing profile classifications of incoming packets and applies the corresponding adaptive routing profile to make routing decisions.

In some cases, the adaptive routing profiles may specify different thresholds for grading egress ports based on congestion levels. For example, a profile for latency-sensitive traffic may use lower thresholds, causing the routing algorithm to react more quickly to slight increases in port congestion.

In some embodiments, the adaptive routing profiles may define different routing modes for various adaptive routing profile classifications. For instance, a profile for TCP traffic may implement sticky routing to minimize out-of-order packet delivery, while a profile for RDMA traffic may use free routing to maximize responsiveness to changing network conditions.

Sticky routing may help minimize problems for TCP (and similar protocols) by maintaining consistent path selection for packets within a flow. In this approach, once an initial port is chosen for a TCP flow, subsequent packets of that flow may continue to use the same port unless certain conditions are met. This consistency in routing may help reduce out-of-order packet delivery, which can be particularly problematic for TCP connections. When packets arrive out of order, TCP may interpret this as packet loss and trigger congestion control mechanisms, potentially reducing throughput unnecessarily. By generally keeping packets from the same flow on the same path (subject to some exceptions), sticky routing may help preserve packet ordering and avoid these false congestion signals. In some implementations, sticky routing may allow for occasional path changes if congestion levels on the chosen port exceed specified thresholds. This approach may balance the benefits of consistent routing with the need to adapt to significant network changes. Sticky routing may include several configurable properties, such as: a destination group timer that controls how frequently port changes are allowed for a specific destination group; a port-specific timer that governs how often any traffic can switch from or to a particular egress port; a current-port grade threshold that determines when the currently used port is considered congested enough to require switching; and a candidate-port grade threshold that establishes when an alternative port is considered suitable as a switching candidate.

Free routing may provide benefits for RDMA traffic by allowing more dynamic path selection. In this approach, the routing algorithm may select from among the best-graded ports for each packet, potentially distributing traffic more evenly across available paths. For RDMA workloads, which often involve large data transfers and are sensitive to network congestion, free routing may help maximize throughput and minimize latency by rapidly adapting to changing network conditions. By continuously reevaluating path choices, free routing may allow RDMA traffic to quickly shift away from congested links, potentially improving overall performance and resource utilization in high-performance computing environments.

The solution offers several advantages, including improved congestion management, enhanced quality of service for diverse applications, and more efficient utilization of network resources. By allowing fine-grained control over routing decisions based on packet characteristics, the system can optimize performance in complex network environments such as data centers and AI clusters.

### SYSTEM DESCRIPTION

The following definitions may be used in describing various aspects of the adaptive routing system and method:

Traffic class may refer to a category or classification of network traffic that shares common characteristics or requirements. In some cases, traffic classes may be defined based on factors such as application type, protocol, quality of service requirements, or other attributes specified in packet headers.

Adaptive routing profile may refer to a set of parameters and rules that define how routing decisions are made for a particular class or classes of network traffic. In some cases, an adaptive routing profile may include thresholds for grading ports, routing modes, and other configuration settings that determine how packets are forwarded through a network.

Adaptive routing profile classification may refer to a categorization assigned to packets based on characteristics identified in packet headers or other packet attributes. In some cases, an adaptive routing profile classification may be determined by examining fields such as traffic class indicators, protocol types, DSCP values, VLAN identifiers, Service Level fields, port numbers, or combinations thereof. The adaptive routing profile classification may be used to map packets to corresponding adaptive routing profiles that define appropriate routing behaviors for packets with similar characteristics.

Sticky routing may refer to a routing mode where, once a port is selected for forwarding packets of a particular flow, subsequent packets of that flow continue to be routed through the same port unless certain conditions are met. In some cases, sticky routing may maintain the selected port until congestion levels exceed a specified threshold.

Free routing may refer to a routing mode where the egress port for each packet is dynamically selected based on current network conditions. In some cases, free routing may involve randomly selecting from among the best-graded ports for each packet.

Grade may refer to a value or score assigned to a port to indicate its desirability for packet forwarding. In some cases, grades may be calculated based on congestion levels, with lower grades indicating less congested paths and higher grades indicating more congested paths.

The thresholds for grading ports may be defined in bytes to represent queue depth. Each port may contain multiple egress queues scheduled in a pre-configured hierarchy using strict priority and weighted round robin scheduling, with different weights per queue. In some cases, these thresholds may be used to determine when to transition between different grades based on the current occupancy of port queues. The adaptive routing profile may define which queues to consider for grading purposes, such as only the packet's traffic class queue, all port queues, or a subset of port queues. For example, if a traffic class is the highest priority, the grading may consider only the packets pending on that specific queue, while for lower priority traffic classes, the grading may consider all packets pending on the port since they are affected by higher priority traffic.

Adaptive routing may use queue grades to indicate congestion levels, with higher grades indicating more congestion. In some cases, the routing algorithm may prefer ports with lower grades when making forwarding decisions to avoid congested paths.

Adaptive routing in network devices may dynamically select egress ports for packets based on current network conditions. In some cases, adaptive routing systems may use queue grades to represent congestion levels at different ports, with lower grades indicating less congested paths. Network devices implementing adaptive routing may continuously monitor network metrics such as queue depths and link utilization to make real-time routing decisions.

In some implementations, a network device may support multiple adaptive routing profiles tailored to different adaptive routing profile classifications. This approach may allow for more granular control over routing decisions based on the unique requirements and characteristics of various types of network traffic. By utilizing multiple adaptive routing profiles, the system may optimize performance, enhance congestion management, and improve overall network efficiency across diverse traffic patterns and application needs.

The network device implementing multiple adaptive routing profiles may be a switch in a data center network. In some cases, the network device may be part of an AI or GPU cluster, where specialized traffic patterns and performance requirements may benefit from customized routing profiles.

Different adaptive routing profile classifications may have distinct sensitivities to factors such as latency, throughput, or out-of-order packet delivery. By applying specific routing profiles to each adaptive routing profile classification, the network device may make routing decisions that are better suited to the needs of that particular type of traffic. For example, latency-sensitive traffic may use a profile with lower congestion thresholds, causing it to be routed away from slightly congested ports more quickly. In contrast, bulk data transfer traffic may use a profile with higher thresholds, allowing it to continue using ports with higher queue depths before rerouting.

In some embodiments, the adaptive routing profiles may specify different thresholds for allowing the use of non-minimal routes. In certain network topologies, such as Dragonfly topologies (Dragonfly+: Low Cost Topology for Scaling Datacenters | IEEE Conference Publication | IEEE Xplore), non-minimal routes (routes that pass through more nodes than the shortest path) may be used to maximize bandwidth when minimal routes become congested.

The adaptive routing profile may define a threshold based on queue depth at which the network device begins to consider non-minimal routes for packet forwarding. For example, when queue depths on minimal route ports exceed a specified threshold, the routing algorithm may select from among non-minimal route ports to avoid congestion. Different profiles may use different thresholds for this transition, allowing traffic classes that prioritize bandwidth over latency to use non-minimal routes more readily than traffic classes that prioritize low latency.

The use of multiple adaptive routing profiles may provide several potential benefits. These may include improved overall network performance, more efficient resource utilization, and enhanced quality of service for different types of applications. By tailoring routing decisions to the specific needs of each adaptive routing profile classification, the system may be better equipped to handle the diverse and dynamic nature of modern network traffic.

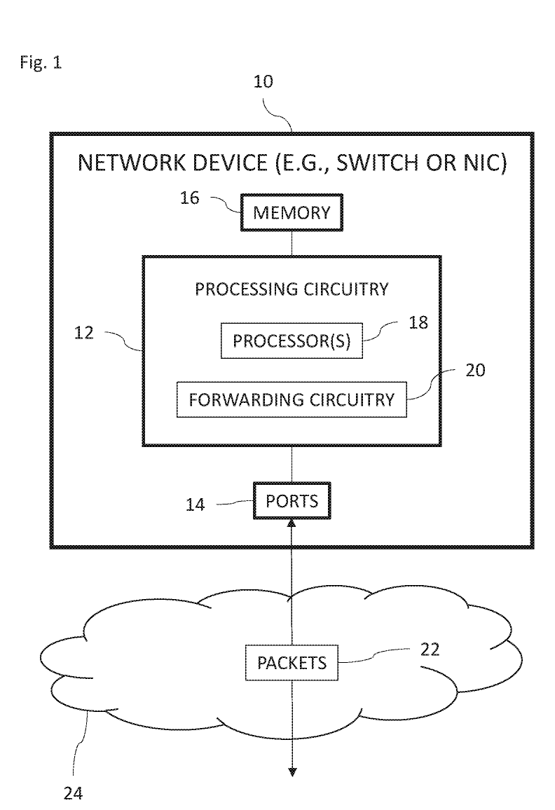

Reference is now made to FIG. 1, which is a simplified block diagram illustrating a network device 10 according to some embodiments. The network device 10 may include processing circuitry 12, a plurality of ports 14, and memory 16.

The processing circuitry 12 may comprise one or more processor(s) 18 and forwarding circuitry 20. The processor(s) 18 and forwarding circuitry 20 may work together to process and forward packets 22 received through the ports 14.

The ports 14 may provide interfaces for receiving and transmitting packets 22 to and from a network 24. The memory 16 may connect to the processing circuitry 12 and may store data and instructions used by the processor(s) 18 and forwarding circuitry 20.

The processing circuitry 12 may be configured to determine adaptive routing profile classifications of the received packets 22 (e.g., on a packet-by-packet basis). In some cases, the processing circuitry 12 may determine the adaptive routing profile classifications of the packets 22 based on information in headers of the received packets 22.

In some cases, the processing circuitry 12 may determine the adaptive routing profile classifications of the packets 22 based on various fields in the packet headers. For example, the processing circuitry 12 may examine the Differentiated Services Code Point (DSCP) field in IPv4 or IPv6 headers to identify quality of service requirements. The DSCP value may indicate whether the packet belongs to a low-latency, high-throughput, or best-effort adaptive routing profile classification.

The processing circuitry 12 may also analyze the protocol field in IP headers to determine the type of traffic. For instance, packets with protocol number 6 may be identified as TCP traffic, while packets with protocol number 17 may be classified as UDP traffic. This information may be used to apply appropriate routing profiles for different transport layer protocols.

In some implementations, the processing circuitry 12 may inspect port numbers in TCP or UDP headers to identify specific applications or services. For example, packets with destination port 80 or 443 may be classified as web traffic, while packets with port 22 may be identified as SSH traffic.

For InfiniBand networks, the processing circuitry 12 may examine the Service Level (SL) field in the Local Route Header (LRH) to determine the adaptive routing profile classification. Different SL values may correspond to various quality of service levels or traffic types within the InfiniBand fabric.

In some cases, the processing circuitry 12 may use the Virtual LAN (VLAN) tag in Ethernet frames to identify adaptive routing profile classifications. Organizations may assign different VLAN IDs to separate traffic types, allowing the network device to apply appropriate routing profiles based on the VLAN membership.

The processing circuitry 12 may also consider the Type of Service (ToS) field in IPv4 headers or the Traffic Class field in IPv6 headers. These fields may provide information about delay, throughput, and reliability requirements, which may be used to map packets to appropriate adaptive routing profile classifications and routing profiles.

The processing circuitry 12 may be further configured to make adaptive routing decisions for the packets 22 based on different adaptive routing profiles associated with the adaptive routing profile classifications of the packets 22. The memory 16 may store data of the different adaptive routing profiles. In some cases, the memory 16 may also store a mapping between the different adaptive routing profiles and the different adaptive routing profile classifications.

After making the adaptive routing decisions, the processing circuitry 12 may be configured to forward the received packets 22 to the ports 14 according to the adaptive routing decisions.

The network device 10 may receive packets 22 through ports 14, process them using processing circuitry 12, and forward them through ports 14 to network 24. The forwarding circuitry 20 may handle the packet forwarding operations while the processor(s) 18 may manage the overall operation of network device 10 including managing aspects of adaptive routing based on different adaptive routing profile classifications.

In some cases, the network device 10 may be a switch, router, multi-port network interface controller (NIC), or other networking equipment capable of implementing adaptive routing with multiple profiles for different adaptive routing profile classifications.

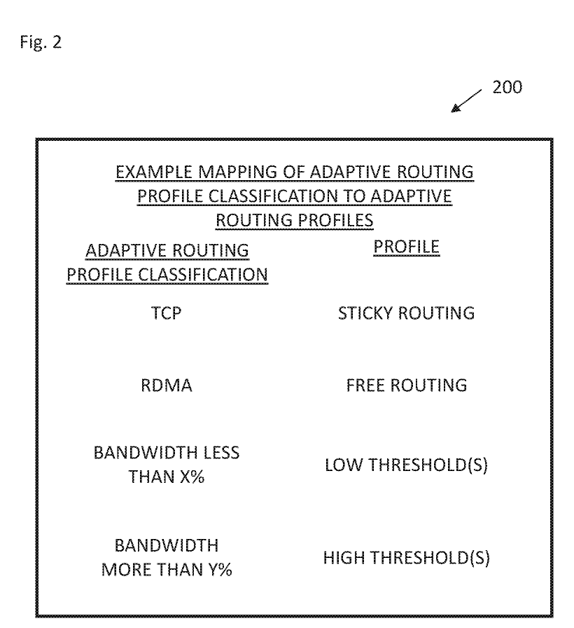

Reference is now made to FIG. 2, which is a view of an example mapping table 200 for use with the network device 10 of FIG. 1. The mapping table 200 may be used to map different adaptive routing profile classifications to specific adaptive routing profiles in network device 10.

In some cases, the mapping table 200 may include multiple entries, with each entry associating a particular adaptive routing profile classification with a corresponding adaptive routing profile. For example, the mapping table 200 may include an entry mapping a TCP adaptive routing profile classification to a sticky routing profile. In another example, the mapping table 200 may include an entry mapping an RDMA adaptive routing profile classification to a free routing profile.

The processing circuitry 12 of the network device 10 may use the mapping table 200 to determine which adaptive routing profile to apply for packets of different adaptive routing profile classifications. In some cases, at least some of the ports 14 may receive packets over the network of a first adaptive routing profile classification and a second adaptive routing profile classification. The processing circuitry 12 may make adaptive routing decisions for packets of the first adaptive routing profile classification based on a first adaptive routing profile associated with the first adaptive routing profile classification. Similarly, the processing circuitry 12 may make adaptive routing decisions for packets of the second adaptive routing profile classification based on a second adaptive routing profile associated with the second adaptive routing profile classification.

The network device 10 may be configured to handle multiple adaptive routing profile classifications with defined bandwidth ratios. In some cases, the first adaptive routing profile classification may have a lower bandwidth share of traffic than the second adaptive routing profile classification.

For example, the mapping table 200 may include an entry mapping an adaptive routing profile classification for traffic with low bandwidth utilization (less than X%) to a low threshold(s) profile, while mapping an adaptive routing profile classification for traffic with high bandwidth utilization (more than Y%) to a high threshold(s) profile (as compared to the low thresholds).

The mapping table 200 may be stored in the memory 16 of the network device 10. The processing circuitry 12 may access the mapping table 200 when making adaptive routing decisions based on the adaptive routing profile classification of received packets 22.

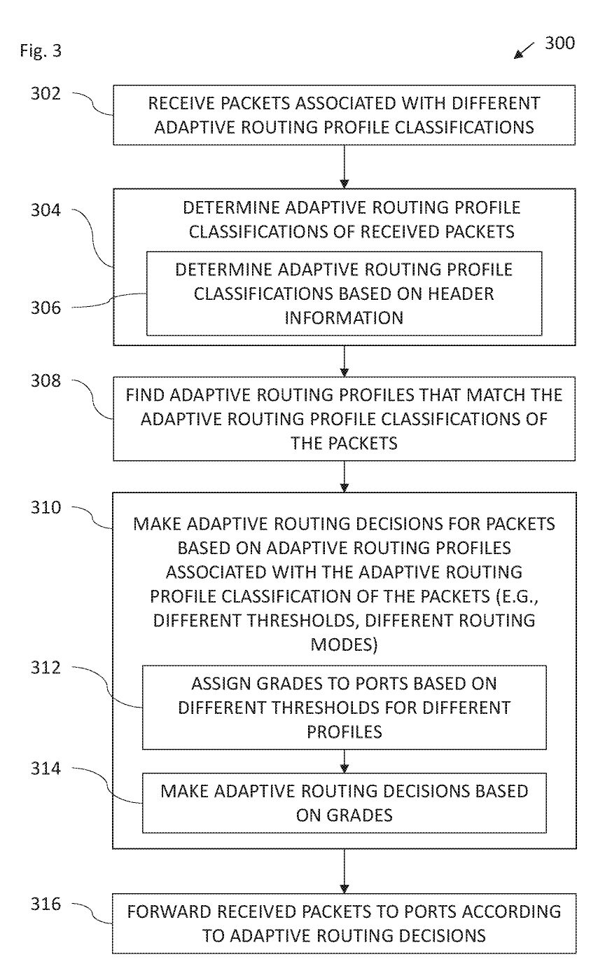

Reference is now made to FIG. 3, which is a flowchart illustrating a method 300 for adaptive routing in network device 10 of FIG. 1. The method 300 may include several steps for processing and routing packets based on their adaptive routing profile classifications and corresponding adaptive routing profiles.

The method 300 may begin at step 302 with receiving packets associated with different adaptive routing profile classifications at a plurality of ports. These packets may belong to different adaptive routing profile classifications, each potentially requiring different routing strategies.

At step 304, the method 300 may determine adaptive routing profile classifications of the received packets. This step may include substep 306, where adaptive routing profile classifications are determined based on header information in the received packets. For example, the adaptive routing profile classification may be identified from specific fields in the packet headers that indicate the type of traffic, quality of service requirements, protocol types, or other attributes that can be used to classify packets for adaptive routing purposes.

The method 300 may proceed to step 308, where adaptive routing profiles that match the adaptive routing profile classifications of the packets are found. In some cases, this may involve looking up a mapping between adaptive routing profile classifications and corresponding adaptive routing profiles stored in memory 16 of the network device 10.

At step 310, adaptive routing decisions may be made for packets based on adaptive routing profiles associated with the adaptive routing profile classifications of the packets. This step may include several sub-steps for assigning grades to ports and making routing decisions based on these grades.

Substep 312 may involve assigning grades to ports based on different thresholds for different profiles. For example, a first adaptive routing profile for a first adaptive routing profile classification may include at least one first threshold for grading the ports, while a second adaptive routing profile for a second adaptive routing profile classification may include at least one second threshold for grading the ports. These thresholds may be different, allowing for customized grading of ports for different adaptive routing profile classifications.

In some cases, the method 300 may assign a first set of grades to the ports for the first adaptive routing profile classification based on the at least one first threshold specified in the first adaptive routing profile. Similarly, a second set of grades may be assigned to the ports for the second adaptive routing profile classification based on the at least one second threshold specified in the second adaptive routing profile.

The first adaptive routing profile may include lower thresholds for grading the ports compared to the second adaptive routing profile. This approach may be particularly useful when the first adaptive routing profile classification has a lower bandwidth share of traffic than the second adaptive routing profile classification. Lower thresholds may be used for adaptive routing profile classifications with lower bandwidth utilization, allowing for more sensitive congestion detection and routing adjustments for these classifications.

At step 314, adaptive routing decisions may be made based on the grades assigned to the ports. The method 300 may make adaptive routing decisions for the packets based on the first set of grades of the ports for packets of the first adaptive routing profile classification and the second set of grades of the ports for packets of the second adaptive routing profile classification.

In some cases, the method 300 may make the adaptive routing decisions for the packets of the first adaptive routing profile classification using a first routing mode based on the first adaptive routing profile. Concurrently, the method 300 may make the adaptive routing decisions for the packets of the second adaptive routing profile classification using a second routing mode based on the second adaptive routing profile.

For example, the method 300 may make the adaptive routing decisions for the packets of the first adaptive routing profile classification using sticky routing based on the first adaptive routing profile. Sticky routing may keep using the same port for a flow unless congestion increases significantly. This approach may be beneficial for adaptive routing profile classifications sensitive to out-of-order packet delivery, such as TCP traffic.

On the other hand, the method 300 may make the adaptive routing decisions for the packets of the second adaptive routing profile classification using free routing based on the second adaptive routing profile. Free routing may select randomly from the best-grade ports for each packet, providing more dynamic load balancing for adaptive routing profile classifications that are less sensitive to packet ordering, such as RDMA traffic.

The method 300 may conclude at step 316, where the received packets are forwarded to ports according to the adaptive routing decisions. This step ensures that each packet is sent out on the port determined to be optimal based on its adaptive routing profile classification and the current network conditions.

By utilizing different adaptive routing profiles with customized thresholds and routing modes for different adaptive routing profile classifications, the method 300 may provide more efficient and tailored packet routing in network devices handling diverse types of network traffic.

In some cases, the adaptive routing system may be implemented in various network environments and configurations beyond those described previously. For example, the adaptive routing profiles may be optimized for different traffic patterns in artificial intelligence (AI) and graphics processing unit (GPU) workloads.

In AI and GPU clusters, network traffic often exhibits unique characteristics such as bursty communication patterns, all-to-all data exchanges, and sensitivity to latency. The adaptive routing profiles may be tailored to address these specific needs. For instance, a profile for AI training workloads may prioritize low latency and use lower queue depth thresholds to trigger rerouting decisions more quickly. Conversely, a profile for large-scale data ingest operations in GPU clusters may use higher thresholds to accommodate larger bursts of traffic without unnecessary rerouting.

In some cases, the system may support the creation of custom adaptive routing profile classifications beyond standard quality of service classifications. Network administrators may define application-specific adaptive routing profile classifications and associate them with tailored routing profiles to meet unique performance requirements.

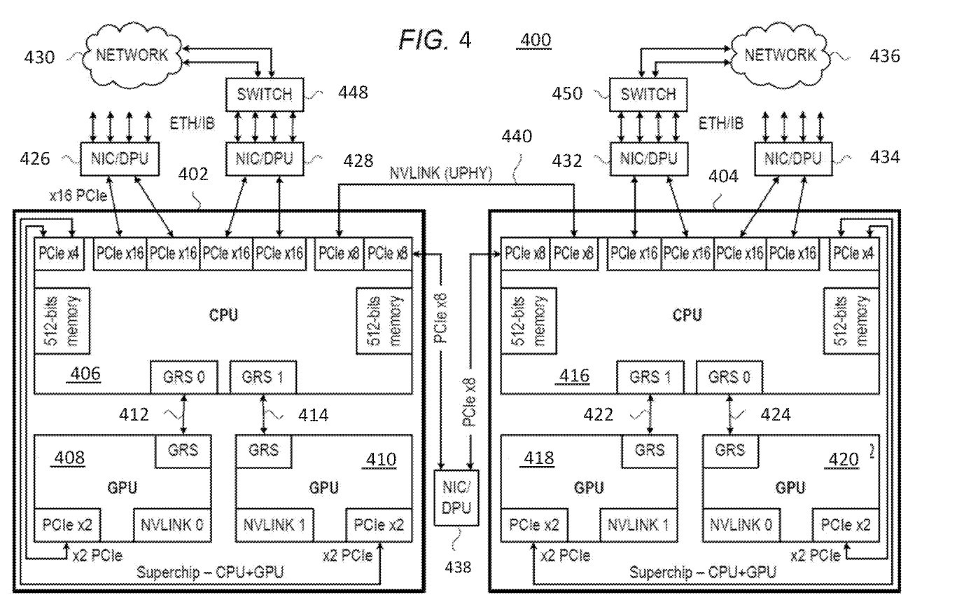

Reference is now made to FIG. 4, which is a block diagram that schematically illustrates a computing system 400, e.g., a data center or a High-Performance Computing (HPC) cluster, in accordance with an embodiment of the present disclosure.

System 400 comprises a plurality of subsystems, e.g., multiple processing devices coupled to each other, multiple network devices, and multiple networks, according to at least one embodiment. Computing system 400 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 400 and to one or more external networks 430, 436. In the present example, system 400 comprises a packet switch 448 that connects NIC/DPU 428 to network 430, and a packet switch 450 that connects NIC/DPU 432 to network 436.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 400 can include one or more CPUs and one or more GPUs.

FIG. 4 also demonstrates an example architecture of a multi-GPU architecture. As illustrated in the figure, computing system 400 includes a processing device 402 with a multi-GPU architecture. In particular, processing device 402 may be a system-on-chip and includes multiple subsystems such as a CPU 406, a GPU 408, and a GPU 410. CPU 406 can be coupled to GPU 408 via a die-to-die (D2D) or chip-to-chip (C2C) interconnect 412, such as a Ground-Referenced Signaling interconnect (GRS interconnect). CPU 406 can be coupled to GPU 410 via a D2D or C2C interconnect 414. CPU 406 can also couple to GPU 408 and GPU 410 via PCIe interconnects.

CPU 406 can be coupled to one or more NICs or DPUs, which are coupled to one or more networks. For example, as illustrated in FIG. 4, CPU 406 is coupled to a first NIC/DPU 426, which is coupled to a network 430. CPU 406 is also coupled to a second NIC/DPU 428, which is coupled to network 430 via switch 448. NIC/DPU 426 and NIC/DPU 428 can be coupled to network 430 over Ethernet (ETH), NVLINK or InfiniBand (IB) connections, for example.

Computing system 400 also includes a processing device 404 with a multi-GPU architecture. In particular, processing device 404 includes multiple subsystems including a CPU 416, a GPU 418, and a GPU 420. CPU 416 can be coupled to GPU 418 via a D2D or C2C interconnect 422. CPU 416 can be coupled to GPU 420 via a D2D or C2C interconnect 424. CPU 416 can also couple to GPU 418 and GPU 420 via PCIe interconnects. CPU 416 can be coupled to one or more NICs or DPUs, which are coupled to one or more networks. For example, as illustrated in FIG. 4, CPU 416 is coupled to a first NIC/DPU 432, which is coupled to a network 436. CPU 416 is also coupled to a second NIC/DPU 434, which is coupled to network 436 via switch 450. NIC/DPU 432 and NIC/DPU 434 can be coupled to network 436 over Ethernet (ETH), NVLINK or InfiniBand (IB) connections.

In at least one embodiment, processing device 402 and processing device 404 can communicate with each other via a NIC/DPU 438, such as over PCIe interconnects. Processing device 402 and processing device 404 can also communicate with each other over a high-bandwidth communication interconnect 440, such as an NVLink interconnect or other high-speed interconnects. The packet switches in FIG. 4 may comprise, for example, Nvidia Quantum-2 switches. The NICs/DPUs in the figure may comprise, for example, Nvidia Bluefield DPUs.

The network switch may include any of the following: ports where network cables connect; switching fabric that manages data transfer between ports; a MAC address table that stores device addresses and port information; a forwarding engine that directs data packets to the correct ports; buffer memory that temporarily holds data to manage traffic; a management processor that handles configuration and monitoring in managed switches; a power supply that provides electrical power; a cooling system that keeps the switch from overheating; firmware that controls the switch; LED Indicators that show status and activity; and networking modules (in modular switches) that allow for additional ports or features.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The flowchart and block diagrams in the figures illustrate the architecture, functionality, and operation of possible implementations of systems, methods and computer program products according to various examples of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various examples of the present disclosure have been presented for purposes of illustration, but are not intended to be exhaustive or limited to the examples disclosed. Many modifications and variations will be apparent to those of ordinary skill in the art without departing from the scope and spirit of the described examples.

As used herein, the singular form "a", "an" and "the" include plural references unless the context clearly dictates otherwise.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A network device, comprising:
a plurality of ports to receive packets; and
processing circuitry to:
determine adaptive routing profile classifications of the received packets;
make adaptive routing decisions for the packets based on different adaptive routing profiles associated with the adaptive routing profile classifications of the packets; and
forward the received packets to the ports according to the adaptive routing decisions.

2. The network device according to claim 1, wherein:
at least some of the ports are to receive the packets of a first adaptive routing profile classification and a second adaptive routing profile classification; and
the processing circuitry is to make the adaptive routing decisions for:
the packets of the first adaptive routing profile classification based on a first adaptive routing profile associated with the first adaptive routing profile classification; and
the packets of the second adaptive routing profile classification based on a second adaptive routing profile associated with the second adaptive routing profile classification.

3. The network device according to claim 2, wherein the first adaptive routing profile and the second adaptive routing profile include different thresholds for grading the ports.

4. The network device according to claim 3, wherein the processing circuitry is to:
assign a first set of grades to the ports for the first adaptive routing profile classification based on at least one first threshold specified in the first adaptive routing profile; and
assign a second set of grades to the ports for the second adaptive routing profile classification based on at least one second threshold specified in the second adaptive routing profile; and
make adaptive routing decisions for the packets based on the first set of grades of the ports for the first adaptive routing profile classification and the second set of grades of the ports for the second adaptive routing profile classification.

5. The network device according to claim 3, wherein:
the first adaptive routing profile classification has a lower bandwidth share of traffic than the second adaptive routing profile classification; and
the first adaptive routing profile includes lower thresholds for grading the ports compared to the second adaptive routing profile.

6. The network device according to claim 2, wherein the processing circuitry is to:
make the adaptive routing decisions for the packets of the first adaptive routing profile classification using a first routing mode based on the first adaptive routing profile; and
make the adaptive routing decisions for the packets of the second adaptive routing profile classification using a second routing mode based on the second adaptive routing profile.

7. The network device according to claim 2, wherein the processing circuitry is to:
make the adaptive routing decisions for the packets of the first adaptive routing profile classification using sticky routing based on the first adaptive routing profile; and
make the adaptive routing decisions for the packets of the second adaptive routing profile classification using free routing based on the second adaptive routing profile.

8. The network device according to claim 1, further comprising a memory to store: a mapping between the different adaptive routing profiles and the different adaptive routing profile classifications; and data of the different adaptive routing profiles.

9. The network device according to claim 1, wherein the processing circuitry is to determine the adaptive routing profile classifications of the packets based on information in headers of the received packets.

10. The network device according to claim 1, wherein the adaptive routing profile classifications are based on one or more of: traffic classes indicated in the headers of the received packets; protocol types indicated in the headers of the received packets; eligibility of the packets for adaptive routing as indicated in the headers of the received packets; Differentiated Services Code Point (DSCP) values in the headers of the received packets; Virtual LAN (VLAN) identifiers in the headers of the received packets; Service Level (SL) fields in InfiniBand headers of the received packets; port numbers in transport layer headers of the received packets; a distinction between TCP traffic and RDMA traffic; or a combination of multiple fields in the headers of the received packets.

11. A method for adaptive routing in a network device, comprising:
receiving packets at a plurality of ports;
determining adaptive routing profile classifications of the received packets;
making adaptive routing decisions for the packets based on different adaptive routing profiles associated with the adaptive routing profile classifications of the packets; and
forwarding the received packets to the ports according to the adaptive routing decisions.

12. The method according to claim 11, wherein:
at least some of the ports receive packets of a first adaptive routing profile classification and a second adaptive routing profile classification; and
making the adaptive routing decisions comprises:
making adaptive routing decisions for the packets of the first adaptive routing profile classification based on a first adaptive routing profile associated with the first adaptive routing profile classification; and
making adaptive routing decisions for the packets of the second adaptive routing profile classification based on a second adaptive routing profile associated with the second adaptive routing profile classification.

13. The method according to claim 12, wherein the first adaptive routing profile and the second adaptive routing profile include different thresholds for grading the ports.

14. The method according to claim 13, further comprising:
assigning a first set of grades to the ports for the first adaptive routing profile classification based on at least one first threshold specified in the first adaptive routing profile;
assigning a second set of grades to the ports for the second adaptive routing profile classification based on at least one second threshold specified in the second adaptive routing profile; and
making adaptive routing decisions for the packets based on the first set of grades of the ports for the first adaptive routing profile classification and the second set of grades of the ports for the second adaptive routing profile classification.

15. The method according to claim 13, wherein:
the first adaptive routing profile classification has a lower bandwidth share of traffic than the second adaptive routing profile classification; and
the first adaptive routing profile includes lower thresholds for grading the ports compared to the second adaptive routing profile.

16. The method according to claim 12, wherein making the adaptive routing decisions comprises:
making the adaptive routing decisions for the packets of the first adaptive routing profile classification using a first routing mode based on the first adaptive routing profile; and
making the adaptive routing decisions for the packets of the second adaptive routing profile classification using a second routing mode based on the second adaptive routing profile.

17. The method according to claim 12, wherein making the adaptive routing decisions comprises:
making the adaptive routing decisions for the packets of the first adaptive routing profile classification using sticky routing based on the first adaptive routing profile; and
making the adaptive routing decisions for the packets of the second adaptive routing profile classification using free routing based on the second adaptive routing profile.

18. The method according to claim 11, further comprising storing in a memory: a mapping between the different adaptive routing profiles and the different adaptive routing profile classifications; and data of the different adaptive routing profiles.

19. The method according to claim 11, wherein determining the adaptive routing profile classifications of the packets comprises determining the adaptive routing profile classifications based on information in headers of the received packets.

20. The method according to claim 11, wherein the adaptive routing profile classifications are based on one or more of: traffic classes indicated in the headers of the received packets; protocol types indicated in the headers of the received packets; eligibility of the packets for adaptive routing as indicated in the headers of the received packets; Differentiated Services Code Point (DSCP) values in the headers of the received packets; Virtual LAN (VLAN) identifiers in the headers of the received packets; Service Level (SL) fields in InfiniBand headers of the received packets; port numbers in transport layer headers of the received packets; a distinction between TCP traffic and RDMA traffic; or a combination of multiple fields in the headers of the received packets.
